(19) United States
(12) Patent Application Publication
(10) Pub. No.: US 2013/0258059 A1
(43) Pub. Date: Oct. 3, 2013

(54) THREE-DIMENSIONAL (3D) IMAGE PHOTOGRAPHING APPARATUS AND METHOD

(71) Applicant: SAMSUNG ELECTRONICS CO., LTD., Suwon-si (KR)

(72) Inventors: Gengyu MA, Beijing (CN); Young Su MOON, Seoul (KR); Jung Uk CHO, Hwaseong-si (KR); Ji Yeun KIM, Seoul (KR); Wentao MAO, Beijing (CN)

(73) Assignee: SAMSUNG ELECTRONICS CO., LTD., Suwon-si (KR)

(21) Appl. No.: 13/853,225

(22) Filed: Mar. 29, 2013

(30) Foreign Application Priority Data
Mar. 31, 2012 (CN) 201210101752.8

(51) Int. Cl. H04N 13/02

(52) U.S. Cl. CPC H04N 13/0203
USPC 348/46

(57) ABSTRACT

A three-dimensional (3D) image photographing apparatus includes a photographing unit configured to photograph a first photo, and capture an image after the first photo is photographed; a feature extracting unit configured to extract feature points from the first photo and the image, and match the feature points extracted from the first photo to the feature points extracted from the image; a position and gesture estimating unit configured to determine a relationship between a position and a gesture of the 3D image photographing apparatus when the first photo is photographed, and a position and a gesture of the 3D image photographing apparatus when the image is captured, based on the matched feature points, the photographing unit configured to photograph the image as a second photo in response to the relationship satisfying a predetermined condition; and a synthesizing unit configured to synthesize the first and second photos to a 3D image.

### CROSS-REFERENCE TO RELATED APPLICATION(S)

This application claims the benefit under 35 USC 119(a) of Chinese Patent Application No. 201210101752.8 filed on Mar. 31, 2012, in the State Intellectual Property Office of the People's Republic of China, the entire disclosure of which is incorporated herein by reference for all purposes.

### BACKGROUND

1. Field

The following description relates to a three-dimensional (3D) image photographing apparatus and method.

2. Description of Related Art

Three-dimensional (3D) TV is more and more popular in the commercial electronics market. A user can buy 3D contents, such as 3D movies, and watch them through the 3D TV. However, the user cannot produce 3D contents, such as 3D photos and 3D videos, of the user.

In order to generate a stereo effect in an image, one way is to separate left eye and right eye views of the image. The 3D TV can show different views of an image to left and right eyes, respectively, of a user, so a human brain of the user can perceive a 3D image from the input views. To capture two views of a scene to simulate human stereo vision, two cameras may be placed at two respective places with only a horizontal translation, e.g., difference. Two photos may be taken at the two respective places, and may be synthesized to a 3D photo.

However, the places where the photos are taken may affect the synthesizing of a good 3D photo. For example, a horizontal translation with a suitable distance between the places may result in the synthesizing of a good 3D photo. However, for a handheld camera, it may be difficult for a user to move the camera exactly to a correct position. A small displacement or rotation may affect the synthesizing of a 3D photo. Therefore, there is a need for a 3D image photographing apparatus and method capable of assisting a user to easily capture 3D photos.

### SUMMARY

In one general aspect, a three-dimensional (3D) image photographing apparatus includes a photographing unit configured to photograph a first photo, and capture an image after the first photo is photographed. The apparatus further includes a feature extracting unit configured to extract feature points from the first photo and the image, and match the feature points extracted from the first photo to the feature points extracted from the image. The apparatus further includes a position and gesture estimating unit configured to determine a relationship between a position and a gesture of the 3D image photographing apparatus when the first photo is photographed, and a position and a gesture of the 3D image photographing apparatus when the image is captured, based on the matched feature points, the photographing unit further configured to photograph the image as a second photo in response to the relationship satisfying a predetermined condition. The apparatus further includes a synthesizing unit configured to synthesize the first and second photos to a 3D image.

In another general aspect, a three-dimensional (3D) image photographing method in a 3D image photographing apparatus, includes photographing a first photo, and capturing an image after the first photo is photographed. The method further includes extracting feature points from the first photo and the image, and matching the feature points extracted from the first photo to the feature points extracted from the image. The method further includes determining a relationship between a position and a gesture of the 3D image photographing apparatus when the first photo is photographed, and a position and a gesture of the 3D image photographing apparatus when the image is captured, based on the matched feature points, and photographing the image as a second photo in response to the relationship satisfying a predetermined condition. The method further includes synthesizing the first and second photos to a 3D image.

In still another general aspect, a three-dimensional (3D) image photographing method in a 3D image photographing apparatus, includes photographing a first photo, and capturing an image after the first photo is photographed. The method further includes extracting feature points from the first photo and the image, and matching the feature points extracted from the first photo to the feature points extracted from the image. The method further includes determining a relationship between a position and a gesture of the 3D image photographing apparatus when the first photo is photographed, and a position and a gesture of the 3D image photographing apparatus when the image is captured, based on the matched feature points, and determining whether the relationship satisfies a predetermined condition. The method further includes photographing the image as a second photo, or informing a user to photograph the image as the second photo, in response to the relationship satisfying the predetermined condition, and informing the user to move the 3D image photographing apparatus based on the relationship and the predetermined condition in response to the relationship not satisfying the predetermined condition.

Other features and aspects will be apparent from the following detailed description, the drawings, and the claims.

### BRIEF DESCRIPTION OF THE DRAWINGS

FIG. 1 is a diagram illustrating an example of a three-dimensional (3D) image photographing apparatus.

FIG. 2 is a flowchart illustrating an example of a 3D image photographing method.

FIG. 3 is a flowchart illustrating another example of a 3D image photographing method.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

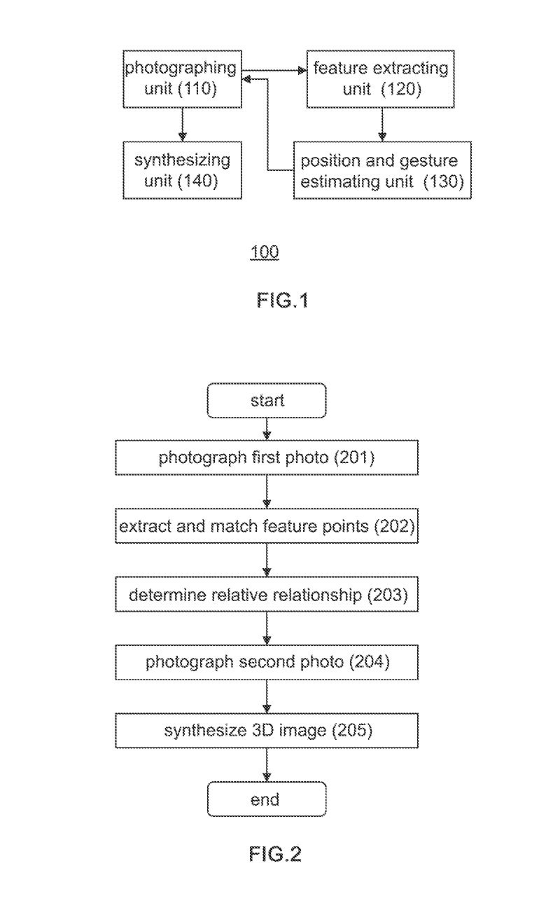

FIG. 1 is a diagram illustrating an example of a three-dimensional (3D) image photographing apparatus. The 3D image photographing apparatus 100 includes a photographing unit 110, a feature extracting unit 120, a position and gesture estimating unit 130 and a synthesizing unit 140.

The photographing unit 110 captures images from an exterior. For example, the photographing unit 110 may capture images, using an image sensor, such as complementary metal-oxide-semiconductor (CMOS) or charge-coupled device (CCD). The photographing unit 110 further photographs a first image captured by the photographing unit 110 as a first photo automatically or in response to an input of a user, such as a pressing of a shutter button. The photographing unit 110 further photographs a subsequent image among images captured by the photographing unit 110 after the first photo is photographed, as a second photo.

To photograph a 3D image, the 3D image photographing apparatus 100 photographs the first and second photos with disparity, and synthesizes the first and second photos to the 3D image. Since the second photo is not arbitrary, not any of the images captured after the first photo is photographed may be photographed as the second photo. Accordingly, a relative relationship is determined between a position and a gesture of the 3D image photographing apparatus 100 when the first photo is photographed, and a position and a gesture of the 3D image photographing apparatus 100 when a subsequent image is captured among the images captured after the first photo is photographed. The relative relationship is determined by extracting and matching feature points from the first photo and the subsequent image. Accordingly, the 3D image photographing apparatus 100 may photograph a proper image as the second photo among the images captured after the first photo is photographed.

The feature extracting unit 120 extracts feature points (e.g., coordinates of content of the actual world) from the first photo. Various methods of extracting feature points may be used. For example, a scale invariant feature transform (SIFT) method or a speeded-up robust features (SURF) method may be used to extract the feature points.

Furthermore, the feature extracting unit 120 extracts feature points from a subsequent image among the images captured by the photographing unit 110 after the first photo is photographed. The feature extracting unit 120 matches or maps the feature points extracted from the first photo to the feature points extracted from the subsequent image. In more detail, the feature extracting unit 120 associates the feature points extracted from the first photo with the feature points extracted from the subsequent image that correspond to a same content of the actual world. For example, the feature extracting unit 120 may associate coordinates of a person's left eye that are extracted from the first photo with coordinates of the person's left eye that are extracted from the subsequent image. Accordingly, the 3D image photographing apparatus 100 may photograph a proper image as the second photo among the images captured after the first photo is photographed, based on the matched feature points.

The position and gesture estimating unit 130 determines a relative relationship between a position and a gesture (e.g., an angle) of the 3D image photographing apparatus 100 when the first photo is photographed, and a position and a gesture of the 3D image photographing apparatus 100 when the subsequent image is captured, based on the feature points extracted and matched from the first photo and the subsequent image. The photographing unit 110 photographs the subsequent image as the second photo based on the determined relative relationship. In more detail, the photographing unit 110 photographs the subsequent image as the second photo when the determined relative relationship satisfies a predetermined condition that allows the first and second photos to be synthesized to the 3D image. The predetermined condition that allows the first and second photos to be synthesized to the 3D image may be defined in a conventional 3D image synthesizing method.

The synthesizing unit 140 synthesizes the first and second photos to the 3D image. Since the 3D image synthesizing method is known, the description thereof is omitted.

For example, when there is a horizontal translation (e.g., a difference in distance) between the 3D image photographing apparatus 100 when the first photo is photographed, and the 3D image photographing apparatus 100 when the subsequent image is captured, the photographing unit 110 photographs the subsequent image as the second photo. That is, the photographing unit 110 photographs the subsequent image as the second photo when the determined relative relationship satisfies the predetermined condition of including the horizontal translation. In more detail, the relative relationship between the position and the gesture of the 3D image photographing apparatus 100 when the first photo is photographed, and the position and the gesture of the 3D image photographing apparatus 100 when the subsequent image is captured, may be indicated in the following example of Equation 1:

(tx, ty, tz, θx, θy, θz) (1)

In Equation 1, tx is a horizontal translation, ty is a vertical translation, tz is a longitudinal translation, θx is a pitch angle, θy is roll angle and θz is a yaw angle.

In this example, when |ty|<Th1, |tz|<Th2, |θx|<Th3, |θy|<Th4, |θz|<Th5 and |tx| is not equal to zero, that is, when there is a horizontal translation in the determined relative relationship, the photographing unit 110 photographs the subsequent image as the second photo. The Th1 is a predetermined threshold for the vertical translation, the Th2 is a predetermined threshold for the longitudinal translation, the Th3 is a predetermined threshold for the pitch angle, the Th4 is a predetermined threshold for the roll angle and the Th5 is a predetermined threshold for the yaw angle. Each of the thresholds Th1, Th2, Th3, Th4 and Th5 may be equal to zero, and a quality of the 3D image synthesized from the first and second photos may be high. Furthermore, since a resolution of the 3D image that is perceived by a human is limited, the quality of the 3D image is not affected when tx, ty, tz, θx, θy and θz reach respective predetermined levels, e.g., respective thresholds Th1, Th2, Th3, Th4 and Th5.

The position and gesture estimating unit 130 may determine the relative relationship based on pairs of the feature points extracted and matched from the first photo and the subsequent image, as indicated in the following examples of Equations 2 and 3:

$$\begin{matrix}{y}_{i} = \frac{\begin{matrix}sin θ x \cdot ( cos θ y + sin θ y \cdot ( sin θ z \cdot {v}_{i} + cos θ z \cdot {u}_{i} ) ) + \\ cos θ x \cdot ( cos θ z \cdot {v}_{i} - sin {θ}_{z} \cdot {u}_{i} ) + ty\end{matrix}}{\begin{matrix}cos θ x \cdot ( cos θ y + sin θ y \cdot ( sin θ z \cdot {v}_{i} + cos θ z \cdot {u}_{i} ) ) - \\ sin θ x \cdot ( cos θ z \cdot {v}_{i} - sin {θ}_{z} \cdot {u}_{i} ) + tz\end{matrix}} & ( 2 ) \\ {u}_{i}^{′} = \frac{cos θ y \cdot ( sin θ z \cdot {v}_{i} + cos {θ}_{z} \cdot {u}_{i} ) - sin θ y + tx}{\begin{matrix}cos θ x \cdot ( cos θ y + sin θ y \cdot ( sin θ z \cdot {v}_{i} + cos θ z \cdot {u}_{i} ) ) - \\ sin θ x \cdot ( cos θ z \cdot {v}_{i} - sin {θ}_{z} \cdot {u}_{i} ) + tz\end{matrix}} & ( 3 )\end{matrix}$$

In Equations 2 and 3, (xᵢ, yᵢ) indicates a coordinate of a feature point extracted from the first photo among a pair of the matched feature points, (uᵢ, vᵢ) indicates a coordinate of a feature point extracted from the subsequent image among the pair of the matched feature points. In addition, i is an index of a feature point, i∈[1, N], and N is a number of all of the extracted feature points.

Coordinates of the pairs of the matched feature points may be substituted into Equation 2, and the unknown variables ty, tz, θx, θy and θz may be determined by solving the Equation (2). Those skilled in the art may understand that at least five pairs of the matched feature points are needed to determine the five unknown variables.

A disparity dᵢ of each of the pairs of the matched feature points may be indicated in the following example of Equation 4:

dᵢ=uᵢ′−xᵢ (4)

Based on a disparity phenomenon of stereo vision, a disparity may be different with respect to feature points with different depths. A feature point with a smaller disparity may be imaged at a position closer to a user in 3D displaying, and a feature point with a bigger disparity may be imaged at a position away from the user. For a different horizontal translation tx, a different disparity dᵢ can be calculated, which means an entire scene is moved away from or closer to the user. When an average depth of the scene approaches a depth of a 3D display apparatus, a watching effect of the user is the best. In this regard, as indicated in the following example of Equation 5, let

d̅=Σᵢ₌₁ⁿdᵢ=0 (5)

In Equation 5, n is an integer, 1<n≦N. In addition, n may be equal to N.

As such, the horizontal translation tx can be determined based on the variables ty, tz, θx, θy and θz determined from Equation 2, and Equations 3, 4 and 5.

In another example, in order to determine a more accurate relative relationship, the unknown variables tx, ty, tz, θx, θy and θz may be determined based on the Levenberg-Marquardt method. As more of the pairs of the matched feature points are used in the Levenberg-Marquardt method, a precision of the relative relationship increases. Since the Levenberg-Marquardt method is known, the description thereof is omitted.

In still another example, although the first and second photos can be synthesized to the 3D image, the synthesized 3D image may include a bad effect, and/or may make a user uncomfortable, giddy, and/or sick. Accordingly, disparities of the first and second photos may be further determined during photographing the second photo.

In more detail, the position and gesture estimating unit 130 may determine a disparity dᵢ=uᵢ′−xᵢ of each of the pairs of the matched feature points based on the determined relative relationship. The position and gesture estimating unit 130 may determine a variance var of the determined disparities, as indicated in the following example of Equation 6:

$$var = \sqrt{\frac{1}{n} {\sum }_{i = 1}^{n} {( {d}_{i} - \overline{d} )}^{2}} \qquad ( 6 )$$

When there is a horizontal translation between the 3D image photographing apparatus 100 when the first photo is photographed, and the 3D image photographing apparatus 100 when the subsequent image is captured, and the determined variance is within a predetermined range, the photographing unit 110 photographs the subsequent image as the second photo. The predetermined range may be from about 5 pixels to about 20 pixels.

In yet another example, the 3D image photographing apparatus 100 may include a photographing guiding unit. The photographing guiding unit may actively inform a user of a manner of moving the 3D image photographing apparatus 100 to photograph the second photo.

In more detail, the photographing guiding unit may determine a manner of adjusting the position and the gesture (e.g., a direction and an amount of a translation and/or a rotation) of the 3D image photographing apparatus 100 when the subsequent image is captured based on the relative relationship determined by the position and gesture estimating unit 130 and the predetermined condition, e.g., |ty|<Th1, |tz|<Th2, |θx|<Th3, |θy|<Th4, |θz|<Th5 and |tx| is not equal to zero. That is, the photographing guiding unit may determine the manner of adjusting so that the relative relationship between the position and the gesture of the 3D image photographing apparatus 100 when the first photo is photographed, and the position and the gesture of the 3D image photographing apparatus 100 when the subsequent image is captured, satisfies the predetermined condition. The photographing guiding unit may inform the user of the determined manner of adjusting by characters, icons and/or drawings displayed on a screen, and/or by voice.

Furthermore, the photographing guiding unit may inform a user to horizontally translate (e.g., move) the 3D image photographing apparatus 100 to the position where the first photo is photographed when the variance of the disparities determined by the position and gesture estimating unit 130 is greater than 20. The photographing guiding unit may inform the user to horizontally translate the 3D image photographing apparatus 100 away from the position where the first photo is photographed when the variance of the disparities determined by the position and gesture estimating unit 130 is less than 5.

Furthermore, when the determined relative relationship satisfies the predetermined condition, the photographing guiding unit may inform a user to photograph the subsequent image (e.g., by pressing the shutter button) as the second photo. Alternatively, when the determined relative relationship satisfies the predetermined condition, the photographing unit 110 may automatically photograph the subsequent image as the second photo.

FIG. 2 is a flowchart illustrating an example of a 3D image photographing method. In operation step 201, a photographing unit (e.g., 110 of FIG. 1) of a 3D image photographing apparatus (e.g., 100 of FIG. 1) photographs a first photo from an exterior. The first photo is a first image captured by the photographing unit. For example, the first photo may be photographed automatically or in response to a pressing of a shutter button by a user.

In operation 202, a feature extracting unit (e.g., 120 of FIG. 1) extracts feature points from the first photo and a subsequent image captured by the photographing unit after the first photo is photographed. The feature extracting unit further matches the feature points extracted from the first photo to the feature points extracted from the subsequent image. For example, the subsequent image may be a living image captured to find a view, a focus, and/or a photographed photo, as long as the subsequent image is captured by the 3D image photographing unit after the first photo is photographed.

In operation 203, a position and gesture estimating unit (e.g., 130 of FIG. 1) determines a relative relationship between a position and a gesture of the 3D image photographing apparatus when the first photo is photographed, and a position and a gesture of the 3D image photographing apparatus when the subsequent image is captured, based on the matched feature points.

In operation 204, the photographing unit photographs the subsequent image as a second photo when the determined relative relationship satisfies a predetermined condition. When the determined relative relationship satisfies the predetermined condition, a photographing guiding unit may inform a user to photograph the subsequent image through the 3D image photographing apparatus as the second photo. When the determined relative relationship does not satisfy the predetermined condition, the photographing guiding unit may inform the user of a manner of moving the 3D image photographing apparatus to photograph the second photo. In other words, the proper subsequent image is photographed as the second photo instead of an improper subsequent image so as to achieve a better effect.

In operation 205, a synthesizing unit (e.g., 140 of FIG. 1) synthesizes the first and second photos to a 3D image.

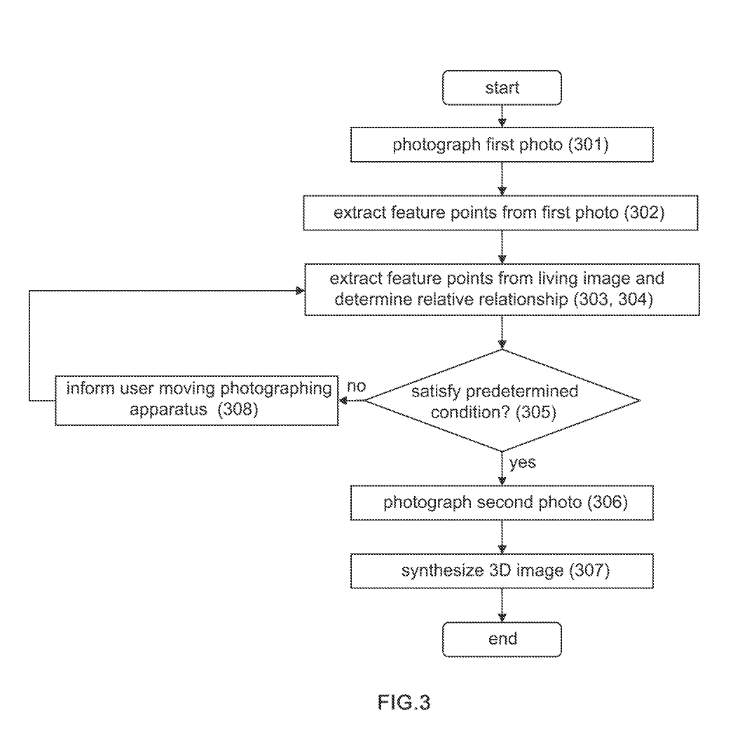

FIG. 3 is a flowchart illustrating another example of a 3D image photographing method. Before photographing a photo, a photographing unit (e.g., 110 of FIG. 1) of a 3D image photographing apparatus (e.g., 100 of FIG. 1) captures a living image for a pre-process, such as, for example, a process of providing a user with a preview of a photographing effect and a process of auto-focusing.

In operation 301, the photographing unit photographs a first photo. For example, the first photo may be photographed automatically or in response to a pressing of a shutter button by a user.

In operation 302, a feature extracting unit (e.g., 120 of FIG. 1) extracts feature points from the first photo.

In operation 303, the feature extracting unit extracts feature points from a living image captured in real-time after the first photo is photographed. The feature extracting unit further matches the feature points extracted from the first photo to the feature points extracted from the living image.

In operation 304, a position and gesture estimating unit (e.g., 130 of FIG. 1) determines a relative relationship between a position and a gesture of the 3D image photographing apparatus when the first photo is photographed, and a position and a gesture of the 3D image photographing apparatus when the living image is captured, based on the matched feature points.

In operation 305, the photographing unit determines whether the determined relative relationship satisfies a predetermined condition. The predetermined condition is described in the above examples, and the subsequent image in the predetermined condition described above is substituted by the living image. If the determined relative relationship satisfies the predetermined condition, the method continues in operation 306. Otherwise, the method continues in operation 308.

In operation 306, the photographing unit photographs the living image as a second photo automatically or in response to a pressing of the shutter button by a user. A photographing guiding unit may inform the user to photograph the living image through the 3D image photographing apparatus as the second photo.

In operation 307, a synthesizing unit (e.g., 140 of FIG. 1) synthesizes the first photo and second photos to a 3D image.

In operation 308, the photographing guiding unit informs a user of a manner of moving the 3D image photographing apparatus to photograph the second photo. In more detail, the photographing guiding unit may determine a manner of adjusting the position and the gesture (e.g., a direction and an amount of a translation and/or a rotation) of the 3D image photographing apparatus 100 when the subsequent image is captured based on the relative relationship determined by the position and gesture estimating unit 130 and the predetermined condition, e.g., |ty|<Th1, |tz|<Th2, |θx|<Th3, |θy|<Th4, |θz|<Th5 and |tx| is not equal to zero. That is, the photographing guiding unit may determine the manner of adjusting so that the relative relationship between the position and the gesture of the 3D image photographing apparatus 100 when the first photo is photographed, and the position and the gesture of the 3D image photographing apparatus 100 when the subsequent image is captured, satisfies the predetermined condition. The photographing guiding unit may inform the user of the determined manner of adjusting by characters, icons and/or drawings displayed on a screen, and/or by voice.

Furthermore, the photographing guiding unit may inform a user to horizontally translate the 3D image photographing apparatus to the position where the first photo is photographed when a variance of disparities determined based on Equation 6 is greater than 20. The photographing guiding unit may further inform the user to horizontally translate the 3D image photographing apparatus away from the position where the first photo is photographed when the variance of the disparities is less than 5.

After operation 308, the method returns to operation 303 to extract feature points from another living image captured in real-time after the first photo is photographed.

The above examples of the 3D image photographing apparatus and method may be implemented on a 2D image photographing apparatus with low cost. Furthermore, the 3D image photographing apparatus and method determine the positions and the gestures when the two photos are photographed based on the matched feature points, instead of using a hardware device, such as gyroscope. Accordingly, the 3D image photographing apparatus and method may be easily implemented on an image photographing apparatus in the related art. Moreover, the 3D image photographing apparatus and method may help a non-professional user photograph 3D images.

The various units and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A three-dimensional (3D) image photographing apparatus comprising:
a photographing unit configured to photograph a first photo, and capture an image after the first photo is photographed;
a feature extracting unit configured to extract feature points from the first photo and the image, and match the feature points extracted from the first photo to the feature points extracted from the image;
a position and gesture estimating unit configured to determine a relationship between a position and a gesture of the 3D image photographing apparatus when the first photo is photographed, and a position and a gesture of the 3D image photographing apparatus when the image is captured, based on the matched feature points, wherein the photographing unit is further configured to photograph the image as a second photo in response to the relationship satisfying a predetermined condition; and
a synthesizing unit configured to synthesize the first and second photos to a 3D image.

2. The 3D image photographing apparatus of claim 1, wherein the predetermined condition comprises the relationship comprising a horizontal translation between the 3D image photographing apparatus when the first photo is photographed and the 3D image photographing apparatus when the image is captured.

3. The 3D image photographing apparatus of claim 1, wherein the feature extracting unit is further configured to:
extract the feature points from the first photo and the image, using a scale invariant feature transform (SIFT) method or a speeded-up robust features (SURF) method.

4. The 3D image photographing apparatus of claim 1, wherein the relationship is indicated by (tx, ty, tz, θx, θy, θz), the tx being a horizontal translation, the ty being a vertical translation, the tz being a longitudinal translation, the θx being a pitch angle, the θy being a roll angle, and the θz being a yaw angle.

5. The 3D image photographing apparatus of claim 4, wherein the predetermined condition comprises the relationship comprising |ty|<Th1, |tz|<Th2, |θx|<Th3, |θy|<Th4, |θz|<Th5, and |tx| being not equal to zero, the Th1 being a threshold for the vertical translation, the Th2 being a threshold for the longitudinal translation, the Th3 being a threshold for the pitch angle, the Th4 being a threshold for the roll angle, and the Th5 being a threshold for a yaw angle.

6. The 3D image photographing apparatus of claim 5, wherein:
the position and gesture estimating unit is further configured to determine disparities of respective pairs of the matched feature points based on the relationship, and determine a variance of the disparities; and
the predetermined condition further comprises the variance being within a predetermined range.

7. The 3D image photographing apparatus of claim 1, further comprising:
a photographing guiding unit configured to determine an adjustment of the position and the gesture of the 3D image photographing apparatus when the image is captured so that the relationship satisfies the predetermined condition, and inform a user of the adjustment.

8. The 3D image photographing apparatus of claim 1, wherein the position and gesture estimating unit is further configured to:
determine the relationship based on the following equations
$$\begin{matrix}{y}_{i} = \frac{\begin{matrix}sin θ x \cdot ( cos θ y + sin θ y \cdot ( sin θ z \cdot {v}_{i} + cos θ z \cdot {u}_{i} ) ) + \\ cos θ x \cdot ( cos θ z \cdot {v}_{i} - sin {θ}_{z} \cdot {u}_{i} ) + ty\end{matrix}}{\begin{matrix}cos θ x \cdot ( cos θ y + sin θ y \cdot ( sin θ z \cdot {v}_{i} + cos θ z \cdot {u}_{i} ) ) - \\ sin θ x \cdot ( cos θ z \cdot {v}_{i} - sin {θ}_{z} \cdot {u}_{i} ) + tz\end{matrix}} \\ {u}_{i}^{′} = \frac{cos θ y \cdot ( sin θ z \cdot {v}_{i} + cos {θ}_{z} \cdot {u}_{i} ) - sin θ y + tx}{\begin{matrix}cos θ x \cdot ( cos θ y + sin θ y \cdot ( sin θ z \cdot {v}_{i} + cos θ z \cdot {u}_{i} ) ) - \\ sin θ x \cdot ( cos θ z \cdot {v}_{i} - sin {θ}_{z} \cdot {u}_{i} ) + tz\end{matrix}} \\ {d}_{i} = {u}_{i}^{′} - {x}_{i} \\ \overline{d} = {\sum }_{i = 1}^{n} {d}_{i} = 0\end{matrix}$$
wherein (xᵢ, yᵢ) indicates a coordinate of the feature point extracted from the first photo among a pair of the matched feature points, (uᵢ, vᵢ) indicates a coordinate of the feature point extracted from the image among the pair of the matched feature points, the tx is a horizontal translation, the ty is a vertical translation, the tz is a longitudinal translation, the θx is a pitch angle, the θy is roll angle, the θz is a yaw angle, n is an integer, 1≦n≦N, and N is a number of the extracted feature points.

9. The 3D image photographing apparatus of claim 8, wherein the position and gesture estimating unit is further configured to:
determine the tx, the ty, the tz, the θx, the θy, and the θz based on a Levenberg-Marquardt method.

10. The 3D image photographing apparatus of claim 1, wherein:
the position and gesture estimating unit is further configured to determine a variance of disparities of respective pairs of matched feature points; and
the predetermined condition comprises the relationship comprising a horizontal translation between the 3D image photographing apparatus when the first photo is photographed and the 3D image photographing apparatus when the image is captured, and the variance being within a predetermined range.

11. The 3D image photographing apparatus of claim 10, wherein the predetermined range is from about 5 pixels to about 20 pixels.

12. The 3D image photographing apparatus of claim 10, further comprising:
a photographing guiding unit configured to inform a user to horizontally translate the 3D image photographing apparatus to the position where the first photo is photographed in response to the variance being greater than a maximum of the predetermined range.

13. The 3D image photographing apparatus of claim 10, further comprising:
a photographing guiding unit configured to inform a user to horizontally translate the 3D image photographing apparatus away from the position where the first photo is photographed in response to the variance being less than a minimum of the predetermined range.

14. The 3D image photographing apparatus of claim 1, further comprising:
a photographing guiding unit configured to inform a user to photograph the image as the second photo, in response to the relationship satisfying the predetermined condition.

15. A three-dimensional (3D) image photographing method in a 3D image photographing apparatus, comprising:
photographing a first photo;
capturing an image after the first photo is photographed;
extracting feature points from the first photo and the image;
matching the feature points extracted from the first photo to the feature points extracted from the image;
determining a relationship between a position and a gesture of the 3D image photographing apparatus when the first photo is photographed, and a position and a gesture of the 3D image photographing apparatus when the image is captured, based on the matched feature points;
photographing the image as a second photo in response to the relationship satisfying a predetermined condition; and
synthesizing the first and second photos to a 3D image.

16. The 3D image photographing method of claim 15, wherein the predetermined condition comprises the relationship comprising a horizontal translation between the 3D image photographing apparatus when the first photo is photographed and the 3D image photographing apparatus when the image is captured.

17. A non-transitory computer-readable storage medium storing a program comprising instructions to cause a computer to perform the method of claim 15.

18. A three-dimensional (3D) image photographing method in a 3D image photographing apparatus, comprising:
photographing a first photo;
capturing an image after the first photo is photographed;
extracting feature points from the first photo and the image;
matching the feature points extracted from the first photo to the feature points extracted from the image;
determining a relationship between a position and a gesture of the 3D image photographing apparatus when the first photo is photographed, and a position and a gesture of the 3D image photographing apparatus when the image is captured, based on the matched feature points;
determining whether the relationship satisfies a predetermined condition;
photographing the image as a second photo, or informing a user to photograph the image as the second photo, in response to the relationship satisfying the predetermined condition; and
informing the user to move the 3D image photographing apparatus based on the relationship and the predetermined condition in response to the relationship not satisfying the predetermined condition.

19. The 3D image photographing method of claim 18, wherein the predetermined condition comprises the relationship comprising a horizontal translation between the 3D image photographing apparatus when the first photo is photographed and the 3D image photographing apparatus when the image is captured.

20. A non-transitory computer-readable storage medium storing a program comprising instructions to cause a computer to perform the method of claim 18.
